(19) United States
(12) Patent Application Publication
(10) Pub. No.: US 2002/0103699 A1
(43) Pub. Date: Aug. 1, 2002

(54) Targeted advertising based on weather conditions

(76) Inventor: Jose Carlos Figueiras Ferreiro, Montevideo (UY)

Correspondence Address: Christopher J. McDonald, Esq., HOFFMAN, WASSON & GITLER, PC, 2361 Jefferson Davis Highway, Suite 522, Arlington, VA, 22202, US

(21) Appl. No.: 09/770,618

(22) Filed: Jan. 29, 2001

(51) Int. Cl. G06F 17/60

(52) U.S. Cl. 705/14

(57) ABSTRACT

The system accounts for prevailing weather conditions in a local area when determining which commercial to be transmitted in that area. The weather conditions, such as temperature and precipitation, are measured and these measurements are used to determine the commercial. For example, if the temperature is above a certain degree, advertisements for cold drinks are shown whereas if the temperature falls below a certain degree, a commercial for hot drinks would be shown. During periods of rain, commercials for foul weather clothing and umbrellas, all-weather tires or resort destinations having tropical weather would be transmitted.

### FIELD OF INVENTION

The invention relates to a method for choosing advertisements based on prevailing weather conditions.

### BACKGROUND OF THE INVENTION

Television has become the dominant form of media in today's society. In 1950, the average household had 4 hours and 35 minutes of viewing time, 3.9 million households (9% of all households), had a television set and 1% of all households had multiple television sets. By 1980, the average household viewing time had risen to 6 hours and 36 minutes with 97.9% of all households, a number equaling 76.3 million households, had a television set. Moreover, 50% of all households had more than one set. In 1999, the viewing time per household has risen to 7 hours and 26 minutes and 99.4 million households, a figure representing 98.2%, have a television set and 74.3% of all households have multiple sets. Television reaches 93% of all people in the United States on any given day. The average person spends more time watching television than with newspapers, radio, magazines and the Internet, combined.

Obviously, such a media that reaches a vast proportion of the population and for such an expended period of time on a daily basis is a powerful advertising opportunity.

In 1950, the early days of television, 3% of all ad volume was television. The advertising revenue spent on television advertisements was 171 million dollars. By 1980, television represented 21.4% of ad volume and accounted for an expenditure of 11.5 billion dollars. In 1999, television has grown to 23.4% of ad volume with an average expenditure of 50.5 billion dollars. Television is now the number one media for advertising revenue. Obviously, with such expenditures committed to television advertising, new ways of making television advertising more effective are always being sought.

One emerging way of increasing the effectiveness of television advertising is targeted advertising. The receiver for cable or satellite television signals monitors and records the types of programs being viewed. From the types of programs being viewed, assumptions are made regarding the types of products in which the viewer would have an interest. It is those types of products which are shown on advertising. Such targeted advertising is based on demographics of the viewing audience.

U.S. Pat. No. 5,732,216 (Logan et al) discloses target advertising based on the subject matter of the program. The user is provided with the opportunity to select additional advertising while suppressing other advertising.

It is also known to measure and display current weather conditions as an overlay display on a television program. This is often done when the temperature is displayed in a corner of a television screen during such programs as local news. U.S. Pat. No. 3,909,818 (Dalke et al) discloses the use of a temperature sensor to record temperature. The temperature is then displayed on a television screen. On a similar note, television stations are able to broadcast weather warnings in the event of extreme weather. The warnings are sent to televisions in operation within a specific area. U.S. Pat. No. 5,565,909 (Thibadeau et al) discloses a method of identifying television receivers. In this way, the location of the receivers is known and specific messages may be sent. These messages may include local weather warnings or local commercial messages.

There is a need in the art for a system that bases the transmitted commercial on prevailing local weather conditions.

It is an object of the invention to provide a system for taking into account weather conditions when choosing a commercial for transmission.

It is another object of the invention to provide a system that measures weather conditions and uses the information to select a particular television commercial.

It is another object of the invention to provide a low cost, efficient system for targeted advertising based on local weather conditions.

These and other objects of the invention will become apparent to one of ordinary skill in the art after reviewing the disclosure of the invention.

### SUMMARY OF THE INVENTION

The system accounts for prevailing weather conditions in a local area when determining which commercial to be transmitted in that area. The weather conditions, such as temperature and precipitation, are measured and these measurements are used to determine the commercial. For example, if the temperature is above a certain degree, advertisements for cold drinks are shown whereas if the temperature falls below a certain degree, a commercial for hot drinks would be shown. During periods of rain, commercials for foul weather clothing and umbrellas, all-weather tires or resort destinations having tropical weather would be transmitted.

### BRIEF DESCRIPTION OF THE DRAWING

FIG. 1 is a flow diagram illustrating the method of the invention.

### DETAILED DESCRIPTION OF THE DRAWING

Television networks broadcast a signal that is picked up and retransmitted by local affiliate stations. Each affiliate station serves a certain geographical area. Some commercials are national commercials, broadcast by the network, while others are broadcast by the affiliate stations. The advertisement may be a timed commercial or a product logo appearing in the corner of the television screen during transmission of a television program.

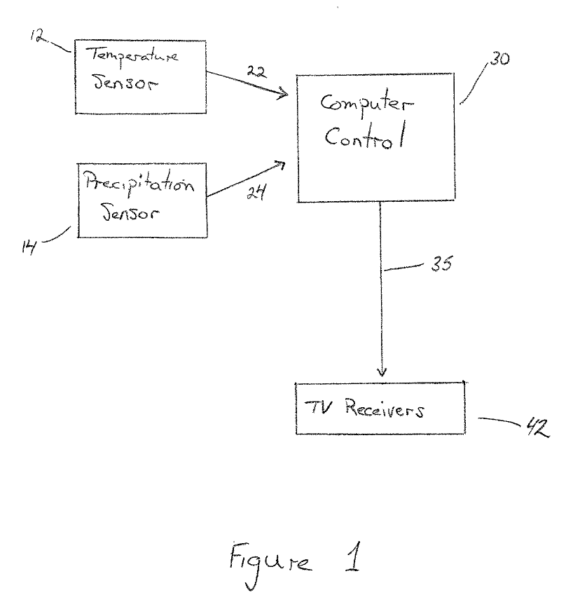

The selection of an advertisement appropriate for the local weather conditions is accomplished either automatically or manually. The automatic selection of an advertisement is shown in the flow chart of FIG. 1. In the embodiment using automatic selection, a temperature sensor 12 and a precipitation sensor 14 measure the prevailing weather conditions. The precipitation sensor can measure not only the presence or absence of precipitation, but the rate of precipitation. Other weather conditions, such as barometric pressure, can also be measured by the appropriate instruments. The temperature sensor produces a signal 22 indicative of the temperature whereas the precipitation sensor produces an output 24 that measures both the presence or absence of precipitation and the rate of accumulation of precipitation.

The signals for temperature 22 and precipitation 24 are inputted into a computer control 30. The computer control 30 receives the signals and uses them with the appropriate software. The appropriate software simply uses the signals inputted from the sensors to choose an advertisement based on the weather conditions. The parameters of temperature and precipitation are used in the predetermined selection criteria. Based on the results of the selection software, a appropriate television commercial is selected. The advertisement transmission 35 is relayed to television receivers 42 receiving the broadcast from the television signal transmission.

The advertisement selection process can also be done manually. In this instance, personnel at the head-end of the television transmission are made aware of the prevailing weather conditions. The quantitative measurements of the weather conditions are used to guide the selection of the advertisement. As previously explained, the subject matter of the advertisement is chosen to be most appealing to the viewer experiencing the same weather conditions used to select the advertisement. The television personnel choose the appropriate advertisement based on the selection criteria previously determined. The advertisement is then transmitted 35 to television receivers 42 receiving that television broadcast. The result is a reception of advertisements that are appropriate for the local weather conditions.

The time of day may also be factored into the selection criteria for the advertisement. For instance, once an advertisement for a hot beverage is chosen based on the measured temperature, an advertisement for coffee can be chosen in the morning, or tea at afternoon tea time. The system can be used to broadcast advertisements over any video monitor. The video mopnitor can be either a television or a computer monitor.

While a preferred embodiment of the invention has been described, variations and modifications would be apparent to one of ordinary skill in the art without departing from the scope of the invention.

I claim:

1. A system for selecting advertisements for transmission comprising:
measuring local weather conditions,
using the weather measurements to select an advertisement, and
transmitting said advertisement.

2. The system of claim 1, wherein said weather conditions are temperature and precipitation.

3. The system of claim 1, wherein said weather conditions are measured by sensors.

4. The system of claim 3, wherein signals from said weather sensors are input into a computer, said computer using the signals to select said advertisement.

5. The system of claim 1, wherein said selection of said advertisement is done by a person.

6. The system of claim 1, wherein the time of day is used as selection criteria.

7. The system of claim 1, wherein said advertisement is over television.

8. The system of claim 1, wherein said advertisement is over a computer monitor.
